(19) United States
(12) Patent Application Publication
(10) Pub. No.: US 2004/0084239 A1
(43) Pub. Date: May 6, 2004

(54) Motor driven rough-road driving four-wheeled vehicle

(75) Inventor: Yuzo Hioki, Hamamatsu-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SUZUKI KABUSHIKI KAISHA, Hamamatsu-shi (JP)

(21) Appl. No.: 10/694,010

(22) Filed: Oct. 28, 2003

(30) Foreign Application Priority Data
Oct. 29, 2002 (JP) 2002-314822

(51) Int. Cl. B60K 1/00

(52) U.S. Cl. 180/291; 180/65.1

(57) ABSTRACT

A motor driven rough-road running four-wheeled vehicle is provided with a lateral pair of front and rear wheels, and the front and rear wheels are driven via a rotation of a rear wheel axle extending from a gear case connected to a driving motor. In such vehicle, a battery unit, including a plurality of batteries, for supplying power to the motor and a controller for controlling electric current passing from the battery unit to the motor are arranged, in a plan view, in a space surrounded by a line connecting inside portions of left-side front and rear wheels, a line connecting inside portions of right-side front and rear wheels, a front wheel axle and the rear wheel axle.

### BACKGROUND OF THE INVENTION

1. Field of the Invention

The present invention relates to a motor-driven rough-road driving four-wheeled vehicle.

2. Related Art

There is known a wheelchair as a conventional motor-driven four-wheeled vehicle such as disclosed in Japanese Patent Laid-open (KOKAI) Publication No. 2001-287665. Such wheelchair is equipped with two front wheels, which are steered by a handle, and two rear wheel driven by a motor having a battery, as a power source, mounted to a vehicle body at a portion below a driver's seat.

Such motor-driven vehicle is driven with no generation of exhaust gas and with generation of low sound or noise, and moreover, the battery can be charged by a domestic power source.

A golf-cart may be listed up as another example of a conventional motor-driven four-wheeled vehicle.

In conventional vehicles or cars, there is less known a small-sized motor-driven four-wheeled vehicle such as rough road driving vehicle suitable for use in leisure, sport and the like. Moreover, in a vehicle which is driven by an ordinal gasoline engine, unpleasant exhaust gas and noise are generated, and in addition, it will be obliged for a driver to make up gasoline, lubricating oil or like, thus involving inconvenient working or labor.

Furthermore, it may be possible to modify the motor-driven wheelchair or golf-cart of the structure mentioned above to a vehicle capable of running on a rough road. Such modification is however not so simple matter because of basic difference in running conditions, sitting attitudes, etc. to obtain good running performance and good steering performance.

### SUMMARY OF THE INVENTION

An object of the present invention is therefore to substantially eliminate defects or inconveniences encountered in the prior art mentioned above and to provide a motor-driven rough-road driving four-wheeled vehicle capable of achieving improved running performance and steering performance.

This and other objects can be achieved according to the present invention by providing a motor driven rough-road driving four-wheeled vehicle, which is provided with a straddle type driver's seat, a lateral pair of front wheels disposed at a front portion of a vehicle body, and a lateral pair of rear wheels, as driving wheels, disposed at a rear portion thereof, and in which the front and rear wheels are driven via a rotation of a rear wheel axle extending from a gear case connected to a driving motor,

wherein a battery unit for supplying power to the motor and a controller for controlling electric current passing from the battery unit to the motor are arranged, in a plan view, in a space surrounded by a line connecting inside portions of left-side front and rear wheels, a line connecting inside portions of right-side front and rear wheels, a front wheel axle and the rear wheel axle.

In a preferred embodiments of this aspect, the battery unit includes a plurality of batteries which are arranged side by side in a longitudinal direction of the vehicle body at substantially central portion thereof.

The motor may be disposed above a central portion of the rear wheel axle and a protection member is disposed below the gear case. It may be better to arrange the controller on a front side of the vehicle body, preferably, in front of the battery unit.

A charger for charging the battery unit may be further disposed in that space and above the battery unit.

The front and rear wheels may be provided with wide-width and low-pressure balloon tires.

According to the above characteristic features or structures, the main parts or members which have relatively heavy weight are disposed in the concentrated manner to the central portion of the vehicle, so that the standing stability and steering performance of the vehicle can be improved. These parts can be easily covered by the body cover, thus improving waterproof performance. In addition, the concentrated arrangement of the main parts or members at the central portion of the vehicle body can eliminate complicated wiring or long connection therebetween, which may result in reduction of power loss or accident, thus elongating the battery life.

Furthermore, the side-by-side arrangement of the plural batteries at the central portion of the body frame makes narrow the width of the body frame at the central portion of the vehicle, which will contribute the reduction of the weight of the vehicle body and, hence, the running performance and steering performance of the vehicle will be able to be also improved.

Still furthermore, the motor is disposed above the center of the rear wheel axle and the protection member such as under guard is arranged below the gear case, and accordingly, the motor and the gear case can be protected from obstacles which may be placed on a road, thus improving the running performance even on a rough (uneven) road. Moreover, by arranging the controller on the front side of the vehicle, for example, in front of the batteries, the controller can be effectively cooled by the running wind, thus well maintaining the performance of the controller.

The nature and further characteristic features of the present invention will be made more clear from the following descriptions made with reference to the accompanying drawings.

### BRIEF DESCRIPTION OF THE DRAWINGS

In the accompanying drawings:

FIG. 1 is a schematic right side view of a motor-driven rough-road driving four-wheeled vehicle according to one embodiment of the present invention;

FIG. 2 is an illustration of a right side view of the motor-driven rough-road driving four-wheeled vehicle, of FIG. 1, from which a body cover is removed;

FIG. 3 is an illustration of a plan view of the motor-driven rough-road driving four-wheeled vehicle, of FIG. 1, from which a body cover is removed; and

FIG. 4 is an illustration of a rear side view of the motor-driven rough-road driving four-wheeled vehicle, of FIG. 1, from which a body cover is removed.

### DESCRIPTION OF THE PREFERRED EMBODIMENT

A preferred embodiment of the present invention will be described hereunder with reference to the accompanying drawings.

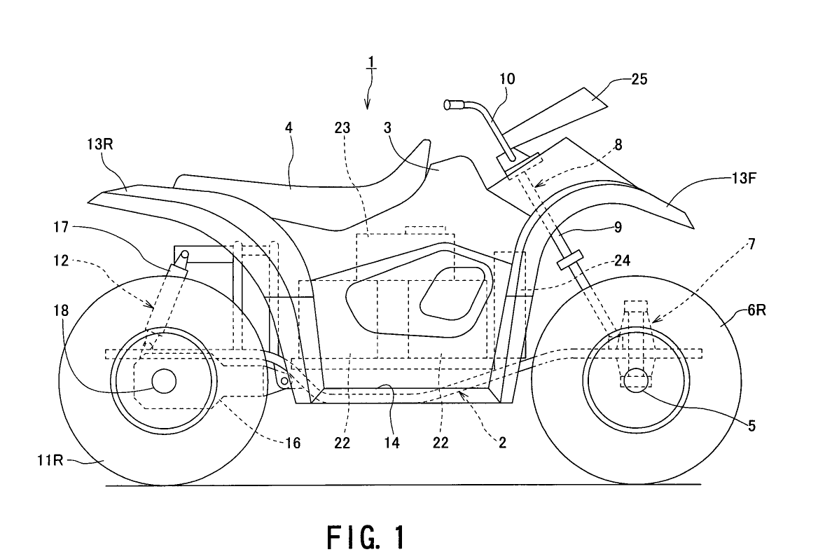

First, with reference to FIG. 1, a motor-driven rough-road driving four-wheeled vehicle 1, such as baggie car, (which may be called merely vehicle hereinlater) has a body frame 2 extending in its longitudinal running direction, and the body frame 2 includes upper and side portions which are covered by a body cover 3 made of resin, for example, and formed integrally with or independently from the body frame. A driver's seat 4 of straddle type is disposed on the upper rear side of the body cover 3.

A lateral pair of front wheels 6L and 6R are mounted to a lateral pair of front wheel axles 5 to be rotatable at a front side in the advancing direction of the vehicle frame body 2. These wheels 6L and 6R are equipped with wide-width low-pressure balloon tires, and these wheels are supported to the body frame 2 to be vertically swingable by a front wheel suspension device 7 together with the front wheel axles 5. Further, in front of the driver's seat 4, there are disposed a steering shaft 9 and a steering bar 10 which constitute a front wheel steering mechanism 8. According to such structure, the front wheels 6L and 6R are steered laterally by the steering bar 10 through the steering shaft 9.

On the other hand, a lateral pair of rear wheels 11L and 11R are mounted to a rear wheel axle 18 to be rotatable at a rear side in the advancing direction of the vehicle frame body 2. These rear wheels 11L and 11R are driven wheels and equipped with wide-width low-pressure balloon tires, and these rear wheels are supported to the body frame 2 to be vertically swingable by a rear wheel suspension device 12.

Fenders 13F and 13R are disposed on both lateral sides of the body cover 3, each of fenders including a pair of lateral front fenders and rear fenders to be integrally therewith or independently therefrom so as to cover the front and rear wheels 6L, 6R and 11L, 11R, respectively. A foot rest 14 is arranged between these front and rear fenders 13F and 13R.

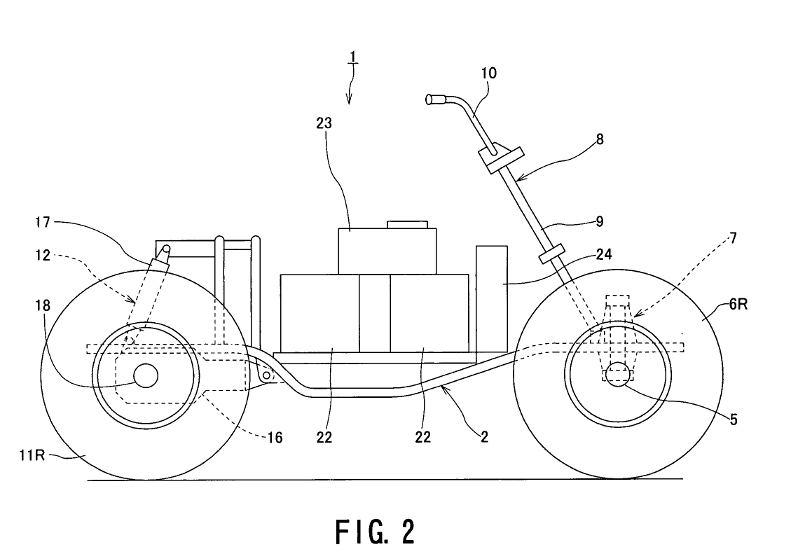

With reference to FIGS. 2 to 4 in addition to FIG. 1, the body frame 2 of the vehicle 1 is formed so as to provide a ladder structure composed of a lateral pair of longitudinally extending main frames 2a, 2a in shape of pipe and a plurality of bridge members 2b crossing therebetween.

An electrically driven motor 15 (merely called “motor” herein later) is disposed on the rear side of the body frame 2 in a horizontally set manner so that its output shaft extends in the width direction of the vehicle body. The motor 15 has one end to which a gear case 16 is connected so as to extend in the rear direction. The gear case 16 has a function as the rear wheel suspension device 12, and also has side portions mounted to the body frame 2. The free end portion of the gear case is elastically supported by the body frame 2 via a shock absorber 17. On the rear side of the gear case 16, there is arranged the rear wheel axle 18 extending in the width direction of the vehicle body.

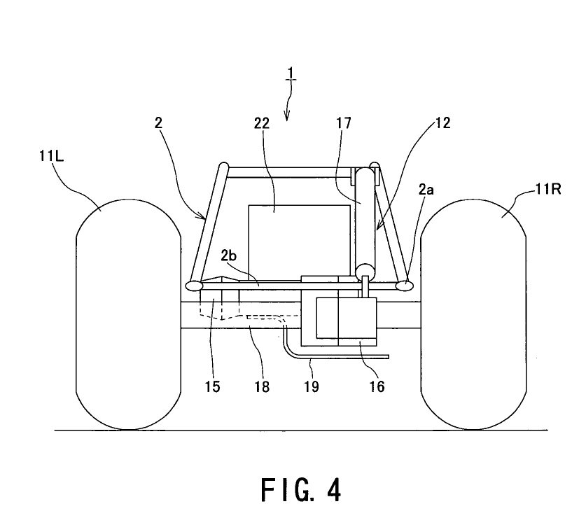

As further shown in FIG. 4, the motor 15 is disposed above the center of the rear wheel axle 18, and an under guard 19 as a plate-shaped protection member is disposed below the gear case 16.

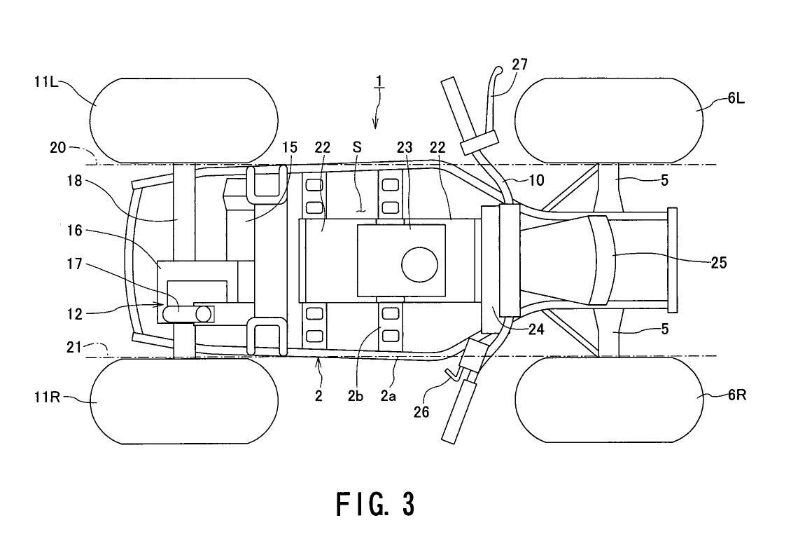

With reference to FIG. 3, in a plan view, in a space S surrounded by a line 20 connecting inside portions of the left-side front and rear wheels 6L and 11L, a line 21 connecting inside portions of the right-side front and rear wheels 6R and 11R, the front wheel axles 5 and the rear wheel axle 18, there are arranged a buttery unit including a plurality of batteries 22 for supplying power to the motor 15, a charger 23 for supplying an electric power from an external source, and a controller 24 for controlling current passing from the batteries 22 to the motor 15. The surroundings of these members are covered by the body cover 3. In a modified arrangement, the charger 23 may be eliminated to be located in this space S.

The foot rests 14 are arranged on both the lateral sides of the batteries 22 and between the front wheels 6L, 6R and the rear wheels 11L, 11R.

The batteries 22 are arranged side by side in the vehicle longitudinal direction at substantially the central portion of the body frame 2, and the charger 23 is mounted thereon. The controller 24 is disposed to a front side portion of the vehicle, for example, in front of the batteries 22 and between the front wheels 6L and 6R.

On the other hand, an indicator panel 25 is provided, for the central portion of the handle bar 10 near the mount portion to the steering shaft 9, so as to extend forward. This indicator panel 25 is, for example, equipped with a main switch, reverse lever for reversely driving the motor 15, speed setting lever, indication lump, etc. through not shown.

A throttle lever 26 may be provided for the right hand end of the steering handle bar 10 and a brake lever 27 may be also provided for the left hand end thereof.

The motor-driven rough (uneven) road driving four-wheeled vehicle according to the present invention of the structure mentioned above will provide the following functions.

A plurality of batteries 22, the charger 23 and the controller 24 are arranged in the space S defined by the line 20 connecting inside portions of the left-side front and rear wheels 6L and 11L, the line 21 connecting inside portions of the right-side front and rear wheels 6R and 11R, the front wheel axles 5 and the rear wheel axle 18.

According to this arrangement, the main parts or members which have relatively heavy weight are disposed in the concentrated manner to the central portion of the vehicle, so that the standing stability and steering performance can be improved, as well as easy covering of this portion with the body cover 3, thus improving waterproof performance.

In addition, the concentrated arrangement of the main parts or members at the central portion of the vehicle body can eliminate complicated wiring or connection therebetween, which may result in reduction of power loss, thus elongating battery life.

Furthermore, the side-by-side arrangement of the plural batteries 22 at the central portion of the body frame 2makes narrow the width of the body frame 2 at the central portion of the vehicle 1, which contributes the reduction of the weight of the vehicle body and, hence, the running performance and steering performance of the vehicle 1 can be also improved.

Still furthermore, the motor 15 is disposed above the center of the rear wheel axle 18 and the under guard 19 is arranged below the gear case 16 as a plate-shaped protection member. According to such arrangement, the motor 15 and the gear case 16 can be protected from obstacles which may be placed on a road, thus improving the running performance even on a rough (uneven) road. Moreover, by arranging the controller 24 on the front side of the vehicle 1, for example, in front of the batteries 22, the controller 24 can be effectively cooled by the running wind, thus well maintaining the performance of the controller 24.

It is to be noted that the present invention is not limited to the described embodiment and many other changes and modifications may be made without departing from the scopes of the appended claims.

What is claimed is:

1. A motor driven rough-road running four-wheeled vehicle, which is provided with a straddle type driver's seat, a lateral pair of front wheels disposed at a front portion of a vehicle body, and a lateral pair of rear wheels, as driving wheels, disposed at a rear portion thereof, and in which the front and rear wheels are driven via a rotation of a rear wheel axle extending from a gear case connected to a driving motor,
wherein a battery unit for supplying power to the motor and a controller for controlling electric current passing from the battery unit to the motor are arranged, in a plan view, in a space surrounded by a line connecting inside portions of left-side front and rear wheels, a line connecting inside portions of right-side front and rear wheels, a front wheel axle and the rear wheel axle.

2. The motor-driven rough-road driving four-wheeled vehicle according to claim 1, wherein said battery unit includes a plurality of batteries which are arranged side by side in a longitudinal direction of the vehicle body at substantially central portion thereof.

3. The motor-driven rough-road driving four-wheeled vehicle according to claim 1, wherein said motor is disposed above a central portion of the rear wheel axle and a protection member is disposed below the gear case.

4. The motor-driven rough-road driving four-wheeled vehicle according to claim 1, wherein said controller is arranged on a front side of the vehicle body in front of the battery unit.

5. The motor-driven rough-road driving four-wheeled vehicle according to claim 1, wherein a charger for charging the battery unit is disposed in said space and above the battery unit.

6. The motor-driven rough-road driving four-wheeled vehicle according to claim 1, said front and rear wheels are provided with wide-width and low-pressure balloon tires.
